(19) United States
(12) Patent Application Publication
(10) Pub. No.: US 2023/0255399 A1
(43) Pub. Date: Aug. 17, 2023

(54) Appliance Stability Apparatus

(71) Applicant: Adrian Rivera, Whittier, CA (US)

(72) Inventor: Adrian Rivera, Whittier, CA (US)

(21) Appl. No.: 17/671,858

(22) Filed: Feb. 15, 2022

Related U.S. Application Data
(63) Continuation of application No. 17/671,832, filed on Feb. 15, 2022.

(51) Int. Cl. A47J 31/58; A47J 31/44

(52) U.S. Cl. CPC A47J 31/58; A47J 31/4407

(57) ABSTRACT

A flare is configured to be coupled to a body of an appliance to increase an anti-tipping stability of the appliance. An appliance can include a body having a bottom portion configured to rest on a surface, and the flare, configured to be coupled to the body, such as coupled to the bottom portion of the body. An appliance includes a body having a bottom portion configured to rest on a surface, and a flare coupled to the body and configured to provide an anti-tipping stability to the appliance. A stop mechanism is configured to be coupled to a body and/or a lid of an appliance, and to limit an amount that the lid can be opened. An appliance can include a body, a lid, and the stop mechanism.

### CROSS-REFERENCE TO RELATED APPLICATIONS

This is a continuation of co-pending U.S. patent application Ser. No. 17/671,832, which was filed on Feb. 15, 2022, the entire disclosure of which is incorporated herein.

### FIELD OF THE INVENTION

The invention relates generally to home appliances, and in particular to apparatus for appliances that prevent the appliance from tipping.

### BACKGROUND OF THE INVENTION

Home appliances are subject to consumer safety testing and must be certified by the testing authorities before they may be offered for sale. For example, for a small appliance to pass Electrical Testing Labs (ETL) and Underwriters Laboratories (UL) certification, the appliance must be stable on a rotating 15° incline plane. Typically, appliances are designed to be symmetrical and have a low center of gravity in order to ensure stability necessary to pass this test. However, for appliances that have a narrow base and/or a center of gravity that does not align with the center of the appliance, this test can be challenging to pass. Further, some appliances have lids that, when open, alter the symmetry of weight distribution of the appliance, which can cause the appliance to fail testing. Often, additional weight is added toward the bottom of such an appliance as a stabilizing feature. However, such a modification adds material and expense to the design, and can make the appliance more difficult to use by a consumer. There is therefore a need for alternative design features that will add stability to an appliance design without.

### BRIEF DESCRIPTION OF THE INVENTION

The invention includes aspects that can increase the anti-tip stability of an appliance, which can be added to or included as part of the appliance, either individually or together. Flares can be coupled to, fixed to, or included as part of the base of the body of the appliance to add anti-tipping stability by expanding the footprint and adding weight to lower the center of gravity. A stop mechanism aspect can be used to limit the range of motion of a lid with respect to the body of the appliance, so that the largest opening angle doesn't exceed a predetermined value that could cause instability. A biasing element can also be included to ensure that the lid also doesn't accidentally close. Either of these aspects alone would add to the anti-tip stability of the appliance, but they can both be included if desired.

According to an aspect of the invention, a flare is configured to be coupled to a body of an appliance to increase an anti-tipping stability of the appliance.

The flare can include, for example, a contact surface configured to make coupling contact with the body of the appliance, and a stability extension configured to extend outward from the body of the appliance.

An appliance can include a body having a bottom portion configured to rest on a surface, and the flare, configured to be coupled to the body. For example, the flare can be coupled to the body, such as coupled to the bottom portion of the body.

The flare can be fixed to the body, such as fixed to the bottom portion of the body.

The body of the appliance has a center of gravity, and the flare can be configured to add footprint area and/or weight to the appliance when coupled to the body, so as to provide the appliance with a center of gravity that is lower than the center of gravity of the body of the appliance. For example, the flare, when coupled to the body, can be configured to provide the appliance with a center of gravity such that the appliance will not tip over when disposed in an upright working position at any location on a rotatable 15-degree plane. As another example, the flare, when coupled to the body, can be configured to provide the appliance with a footprint area such that the appliance will not tip over when disposed in an upright working position at any location on a rotatable 15-degree plane.

The body of the appliance has a footprint, and the flare can be configured to extend the footprint of the body of the appliance.

The appliance can be, for example, a beverage brewer, such as a coffee brewer.

The appliance body can include a container and a handle. One or more flares can be attached to the container, to the handle, or to both.

According to another aspect of the invention, an appliance includes a body having a bottom portion configured to rest on a surface, and a flare coupled to the body and configured to provide an anti-tipping stability to the appliance.

The flare can include a contact surface coupled to the body of the appliance, and a stability extension extending outward from the body of the appliance. The flare can be coupled to the body, such as coupled to the bottom portion of the body.

The body of the appliance has a center of gravity, and the flare is configured to add footprint area and/or weight to the appliance so as to provide the appliance with a center of gravity that is lower than the center of gravity of the body of the appliance. For example, the flare can be configured to provide the appliance with a center of gravity such that the appliance will not tip over when disposed in an upright working position at any location on a rotatable 15-degree plane. As another example, the flare can be configured to provide the appliance with a footprint area such that the appliance will not tip over when disposed in an upright working position at any location on a rotatable 15-degree plane.

The body of the appliance has a footprint, and the flare can be configured to extend the footprint of the body of the appliance.

The appliance can be, for example, a beverage brewer, such as a coffee brewer.

The appliance can include a container and a handle. One or more flares can be attached to the container, to the handle, or to both.

According to another aspect of the invention, a stop mechanism is configured to be coupled to a body of an appliance and/or a lid of an appliance, and to limit an amount that the lid can be opened.

For example, the stop mechanism can include a contact surface configured to make coupling contact with the body of the appliance, and a stop extension configured to engage the lid of the appliance so as to impede opening of the lid beyond a predetermined opening angle. Alternatively, the stop mechanism can include a contact surface configured to make coupling contact with the lid of the appliance, and a stop extension configured to engage the body of the appliance so as to impede opening of the lid beyond a predetermined opening angle.

According to another aspect of the invention, an appliance includes a body, a lid, and the stop mechanism. The lid is hingedly connected to the body and configured to move between a closed position in which the lid covers a top of the body, and a fully open position in which the lid does not cover the body. An opening angle defines an angle between the top of the body and the lid when in the fully open position. The stop mechanism can be configured to limit a maximum opening angle. For example, the stop mechanism can be configured to limit the maximum opening angle to less than 90 degrees, such as in a range of about 50 degrees to about 60 degrees.

The stop mechanism can include a stop block configured to engage the body of the appliance and the lid when the lid is opened to the maximum opening angle. The stop block can be coupled to the lid, and/or to the body of the appliance. The body of the appliance can include a handle, and the stop block can be coupled to the handle.

The stop mechanism can also include a biasing element configured to urge the lid toward the fully open position when the lid is moved toward the closed position past a predetermined bias point. For example, the biasing element can include a spring, such as a torsion spring.

According to another aspect of the invention, an appliance includes a body, a lid, and a stop mechanism attached to the body of the appliance and/or the lid. The lid is hingedly connected to the body and configured to move between a closed position in which the lid covers a top of the body, and a fully open position in which the lid does not cover the body. The stop mechanism is configured to limit an amount that the lid can be opened. An opening angle defines an angle between the top of the body and the lid when in the fully open position.

The stop mechanism can include a contact surface coupled to the body of the appliance, and a stop extension configured to engage the lid of the appliance so as to impede opening of the lid beyond a predetermined opening angle. Alternatively, the stop mechanism can include a contact surface coupled to the lid of the appliance, and a stop extension configured to engage the body of the appliance so as to impede opening of the lid beyond a predetermined opening angle.

The stop mechanism can be configured to limit a maximum opening angle, such as to less than 90 degrees, for example in the range of about 50 degrees to about 60 degrees.

The stop mechanism can include a stop block configured and arranged to engage the body of the appliance and the lid when the lid is opened to the maximum opening angle. The stop block can be coupled to the lid and/or to the body of the appliance. The body of the appliance can include a handle, and the stop block can be coupled to the handle.

The stop mechanism can also include a biasing element configured to urge the lid toward the fully open position when the lid is moved toward the closed position past a predetermined bias point. The biasing element can include, for example, a spring, such as a torsion spring.

The appliance can be a beverage brewer, such as a coffee brewer.

The appliance can also include a flare coupled to the body of the appliance to increase an anti-tipping stability of the appliance.

### BRIEF DESCRIPTION OF THE DRAWINGS

FIG. 1 shows an appliance to which exemplary flares according to the invention are coupled.

FIG. 2 shows an appliance to which exemplary flares according to the invention are coupled, arranged on a power base.

FIG. 3 shows an exemplary flare coupled to a container of the appliance.

FIG. 4 shows an exemplary flare coupled to a handle of the appliance.

FIG. 5 shows two exemplary flares according to the invention.

FIG. 6 shows an appliance having an exemplary stop mechanism according to the invention.

FIG. 7 shows an exemplary stop mechanism according to the invention.

FIG. 8 shows an appliance having an exemplary stop mechanism according to the invention.

FIG. 9 shows an underside of a lid of an appliance having an exemplary stop block and torsion spring according to the invention.

### DETAILED DESCRIPTION OF THE INVENTION

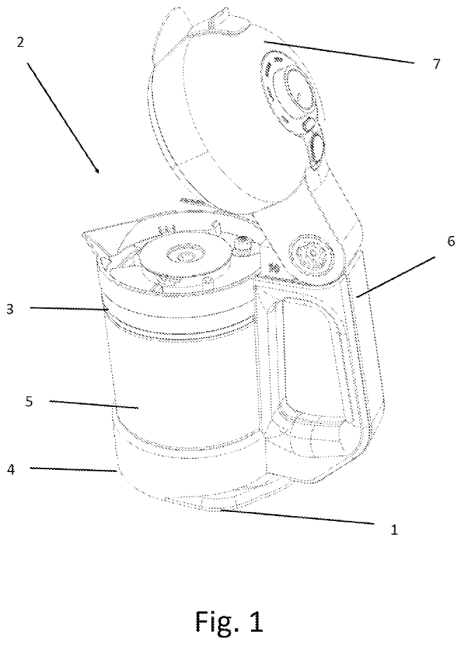

As shown in FIG. 1, an aspect of the invention is a flare 1 that is configured to be coupled to a body 3 of an appliance 2 to increase an anti-tipping stability of the appliance 2. If desired, more than one flare 1 can be coupled at various locations of the appliance 2, and each will contribute to the overall stability of the appliance 2.

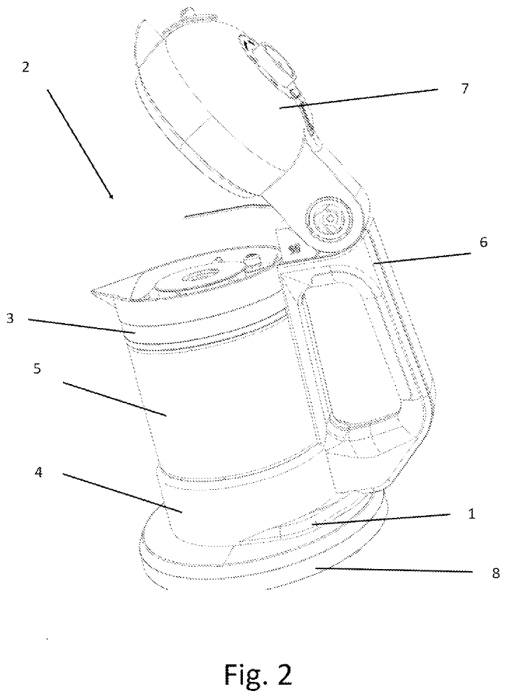

For example, the exemplary appliance 2 can include a body 3 having a bottom portion 4 configured to rest on a surface. In the exemplary embodiment shown in FIG. 2, the appliance 2 is a beverage brewer, which typically is arranged on a power base 8 or the like during the brewing process. However, after a beverage is brewed, the body 3 of the brewer is lifted off the power base 8 to dispense the beverage, and could be placed on a countertop or other surface. The flare 1 can be configured to be coupled to the body 3 to add stability while the appliance 2 body 3 is on this surface. For example, the flare 1 can be coupled to the body 3, such as coupled to the bottom portion 4 of the body 3 as shown in FIG. 1. The flare 1 can be coupled, that is, removably coupled, attached in some manner, or fixed, to the body 3 of the appliance 2. The flare 1 can even be integrated with the body 3 of the appliance 2 during manufacture, such as by molding the body 3 and flare 1 together. The flare 1 can be coupled with the appliance body 3 anywhere that will result in an increase in stability.

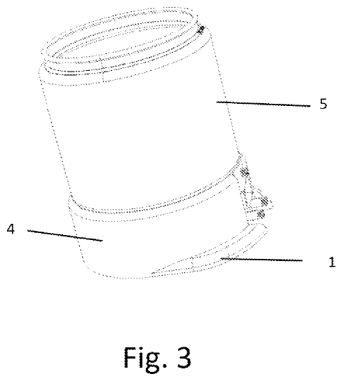

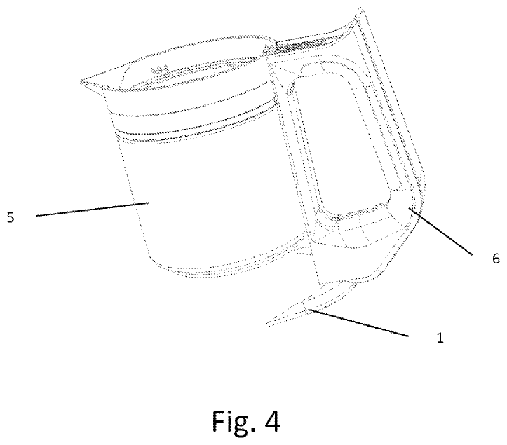

For example, in the case of a beverage brewer, the appliance body 3 can include a container 5 and a handle 6. One or more flares can be attached to the bottom portion 4 of the container 5 portion, to the handle 6, or to both. As shown in FIGS. 3 and 4, a flare 1 can be coupled to either the container 5 portion or the handle 6, or adjacent flares can be coupled one each to the bottom of the container 5 portion and to the bottom of the handle 6. Any number of flares can be coupled anywhere on the appliance body 3 to increase stability of the appliance 2.

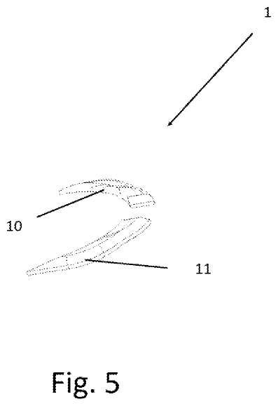

As shown in FIG. 5, the flares 1 can include a contact surface 10 configured to make coupling contact with the body 3 or handle 6 of the appliance 2, and a stability extension 11 configured to extend outward from the body 3 of the appliance 2. The contact surface 10 can include a mating feature that can couple with a corresponding mating feature on the appliance body 3, for removable or fixed coupling or attachment to the appliance body 3. Alternatively, or in addition, the contact surface 10 can be prepped for gluing or otherwise fastening to the appliance body 3, such as by scoring the surface, or applying an adhesive material or adhesive-carrying element to the contact surface 10. The stability extension 11 projects away from the appliance body 3 when coupled to the appliance body 3. If coupled to the bottom end of the appliance body 3, the stability extension 11 adds to the footprint of the appliance body 3 and therefore adds to the anti-tipping stability of the appliance 2. Even if not coupled directly at the bottom of the appliance body 3, the stability extension 11 can prevent tipping of the appliance 2 by acting as a stop structure that contacts the support surface and props the appliance 2 if it starts to tip.

The flare 1 can also add to the center of gravity of the body 3 of the appliance 2. That is, the body 3 has a center of gravity, and the flare 1, when coupled to the body 3, can add footprint area and/or weight to the appliance 2 so as to provide the appliance 2 with a center of gravity that is lower than the center of gravity of the body 3 of the appliance 2. Lowering of the center of gravity in turn adds to the anti-tipping stability of the appliance 2.

In order to pass compliance testing as mentioned above, the flare 1, when coupled to the body 3, is preferably configured to provide the appliance 2 with a center of gravity such that the appliance 2 will not tip over when disposed at any location on a rotatable 15-degree plane. Alternatively, the flare 1 can be configured to provide the appliance 2 with a footprint area such that the appliance 2 will not tip over when disposed at any location on a rotatable 15-degree plane. Of course, the combination of effects of the increase in footprint area and lowering of center of gravity can provide this preferred effect. Further, any measure of increase in anti-tipping stability is a benefit contemplated as an advantage of the invention. Presumably the test would be conducted on the appliance 2 when in an upright working position, that is, when arranged as the appliance 2 would be when in use or when being stored.

The flare 1 can work with any type of appliance 2, including a beverage brewer, such as a coffee brewer, as shown by example only. No limitation on type or size of appliance 2 is contemplated for use with the flare 1 of the invention, which can be sized and proportioned for any such application, for use individually or in multiples.

Although the flare 1 can be provided as a component to be coupled to an appliance 2 individually or multiply, an appliance 2 can be provided that includes one or more of the flares. For example, an appliance 2 that includes a body 3 having a bottom portion 4 configured to rest on a surface can include one or more flares 1 coupled to the body 3 and configured to provide an anti-tipping stability to the appliance 2. As with the flare 1 mentioned above, the appliance 2 including the flare 1 or flares will have a larger footprint and/or added weight to lower the center of gravity of the appliance 2, which in turn will provide great anti-tipping stability to the appliance 2. As mentioned above, the appliance 2 can be any type of appliance 2, such as a beverage brewer, or in particular a coffee brewer. No limitation as to the type or size of the appliance 2 is contemplated. The appliance 2 can be of the type that includes a working portion, such as a container 5, and a handle 6. In this case, one or more flares can be attached to the container 5, to the handle 6, or to both.

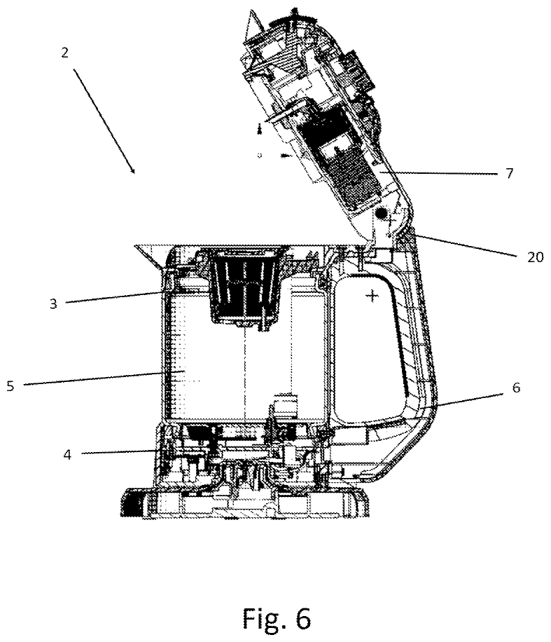

Other features can be added to the appliance 2 instead of or in addition to the flare 1 or flares in order to improve the anti-tip stability of the appliance 2. For example, if the appliance 2 has a lid 7, the balance of the appliance 2 changes when the lid 7 is closed and opened. When the lid 7 opened to a certain extent, the weight can shift to one side of the appliance 2, potentially causing a balance and tipping issue. Thus, the balance of the appliance 2 can be positively affected by limiting the extent to which the lid 7 can be opened. To this end, the invention can include a stop mechanism that is configured to be coupled to the body 3 of the appliance 2 and/or to the lid 7 of the appliance 2, in order to limit the extent that the lid 7 can be opened. For example, a stop mechanism 20 is shown in FIG. 6, attached to the body 3 of the appliance 2, at the top of the handle 6. In this case, the stop mechanism 20 is arranged toward the back of the handle, directly in the path of the lid 7 as the lid is opened. As the lid 7 is pivoted open, the stop mechanism 20 presents an obstruction that blocks further opening of the lid 7 beyond a predetermined point at which the lid 7 engages the stop mechanism 20.

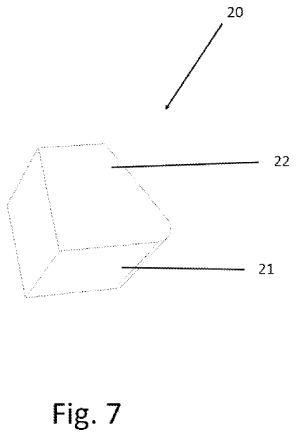

As shown in FIG. 7, the stop mechanism 20 can include a contact surface 21 configured to make coupling contact with the body 3 or lid 7 of the appliance 2, and a stop extension 22 configured to engage the lid 7 or body 3 of the appliance 2 so as to impede opening of the lid 7 beyond a predetermined opening angle. Alternatively, the stop mechanism 20 can include a contact surface 21 configured to make coupling contact with the lid 7 of the appliance 2, and a stop extension 22 configured to engage the body 3 of the appliance 2 so as to impede opening of the lid 7 beyond a predetermined opening angle. That is, the stop mechanism 20 can be coupled to the body 3 of the appliance 2, or to the lid 7, or to both. If the body 3 of the appliance 2 includes a handle 6, the stop block can be coupled to the handle 6 if that placement provides a benefit.

The stop mechanism 20 can be coupled, that is, removably coupled, attached in some manner, or fixed, to the body 3 of the appliance 2 and/or to the lid 7. The stop mechanism 20 can even be integrated with the body 3 of the appliance 2 and/or to the lid 7 during manufacture, such as by molding the body 3 and stop mechanism 20 together. The stop mechanism 20 can be coupled with the appliance 2 body 3 and/or to the lid 7 anywhere that will allow it to limit the opening angle of the lid 7. The contact surface 21 can include a mating feature that can couple with a corresponding mating feature on the appliance body 3 and/or to the lid 7, for removable or fixed coupling or attachment to the appliance body 3 and/or to the lid 7. Alternatively, or in addition, the contact surface 21 can be prepped for gluing or otherwise fastening to the appliance body 3 and/or to the lid 7, such as by scoring the surface, or applying an adhesive material or adhesive-carrying element to the contact surface 21.

The stop mechanism 20 can include, for example, a stop block configured to engage the body 3 of the appliance 2 and the lid 7 when the lid 7 is opened to the maximum opening angle. That is, the stop block can be a solid piece of material or assembly of pieces configured to act as a physical impediment when placed in the path of the lid. The stop block can be, for example, made from a rigid material such as plastic or metal, and for convenience in manufacturing can be made from the same material as the appliance body 3 or lid 7. Alternatively, the stop block can be made from a resilient material, such as rubber or foam. In this case, the stop block can provide a soft stop for the lid 7. If the foam stop block is coupled to both the appliance body 3 and the lid 7, the compression of the stop block will prevent opening of the lid 7 beyond a certain point, based on the properties of the stop block material.

An appliance 2 can also be manufactured to include a body 3, a lid 7, and the stop mechanism 20. That is, the stop mechanism 20 can be integrated as part of the appliance 2, such as being attached to or molded with the appliance body 3 and/or lid 7. Typically, the lid 7 is hingedly connected to the body 3 and configured to move between a closed position in which the lid 7 covers a top of the body 3, and a fully open position in which the lid 7 does not cover the body 3. That is, the lid 7 can swing between two extreme positions, one being fully closed and the other being fully open, and is able to be held at any point between those two extremes. An opening angle defines an angle between the top of the body 3, or the closed position of the lid 7, and the lid 7 when in the fully open position. The stop mechanism 20 can be configured to limit a maximum opening angle, that is, to provide a stop that limits the fully open position of the lid 7. For example, the stop mechanism 20 can be configured to limit the maximum opening angle to less than 90 degrees, to prevent the lid 7 from opening beyond a sidewall of the appliance 2. The angle can be limited to any degree desired, such as in a range of about 50 degrees to about 60 degrees, for any purpose. Preferably, the opening angle is limited to an extent such that the appliance 2 will not tip over when disposed at any location on a rotatable 15-degree plane when the lid 7 is fully opened.

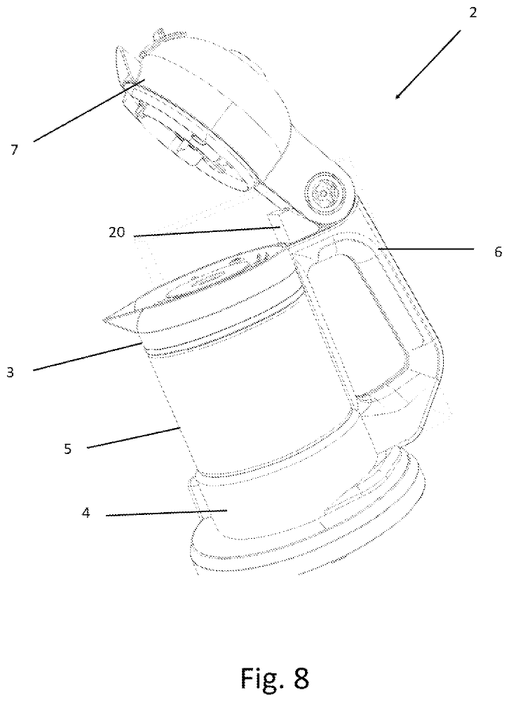

As shown in FIG. 8, the stop mechanism 20 can be arranged on the handle 6 or elsewhere on the appliance body, to the inside of the lid 7. In this case, the lid 7 would include a lip or other extension configured to engage and catch on the stop mechanism after the lid 7 opens a predetermined extent, in order to prevent opening beyond the maximum desired angle.

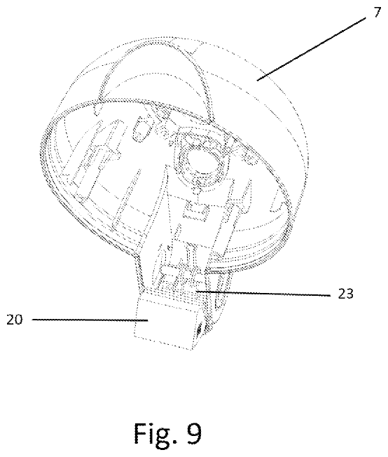

Because the stop mechanism 20 will limit the opening angle of the lid 7, and that opening angle could be less than 90 degrees, the lid 7 could fall back into the closed position once opened if the user doesn't hold the lid 7 in the opened position. Therefore, the lid 7 could include a latch that engages when the lid 7 is fully opened to hold the lid 7 in place, and which can be disengaged by the user when closing the lid 7. Alternatively, the stop mechanism 20 can also include a biasing element 23 configured to urge the lid 7 toward the fully open position when the lid 7 is moved toward the closed position past a predetermined bias point, as shown in FIG. 9. With this biasing element 23 included, a user can open the lid 7 and then leave the lid 7 unattended in the opened position without worrying that the lid 7 will fall back into the closed position.

For example, if the appliance 2 is a beverage brewer, such as a coffee brewer, a user will lift the lid 7 to put ground coffee or a coffee pod into a brewing chamber beneath the lid 7. With the stop block in place, the lid 7 will open only t a certain extent, presumably less than 90 degrees from the closed position. If the biasing element 23 is not included, the lid 7 will have to be held up or it will fall back to the closed position, which can be a nuisance to the user. By urging the lid 7 toward the open position, the biasing element 23 holds the lid 7 in place, leaving the user free to attend to the task of filling the brewing chamber.

The biasing element 23 can be anything that urges the lid 7 toward the open position. For example, the biasing element 23 can include a spring, such as a torsion spring. The torsion spring can be coupled to the lid 7, the appliance body 3, or both, and arranged to hold the lid 7 in the opened position, or at least to provide resistance against the lid 7 to prevent the lid 7 from fully closing.

The invention has been described by way of example and in terms of preferred embodiments. However, the invention as contemplated by the inventor is not strictly limited to the particularly disclosed embodiments. To the contrary, various modifications, as well as similar arrangements, are included within the spirit and scope of the invention. The scope of the appended claims, therefore, should be accorded the broadest reasonable interpretation so as to encompass all such modifications and similar arrangements.

I claim:

1. A stop mechanism configured to be coupled to at least one of a body of an appliance and a lid of an appliance, and to limit an amount that the lid can be opened.

2. The stop mechanism of claim 1, comprising:
a contact surface configured to make coupling contact with the body of the appliance; and
a stop extension configured to engage the lid of the appliance so as to impede opening of the lid beyond a predetermined opening angle.

3. The stop mechanism of claim 1, comprising:
a contact surface configured to make coupling contact with the lid of the appliance; and
a stop extension configured to engage the body of the appliance so as to impede opening of the lid beyond a predetermined opening angle.

4. An appliance, comprising:
a body;
a lid, hingedly connected to the body and configured to move between:
a closed position in which the lid covers a top of the body, and
a fully open position in which the lid does not cover the body; and
the stop mechanism of claim 1;
wherein an opening angle defines an angle between the top of the body and the lid when in the fully open position.

5. The appliance of claim 4, wherein the stop mechanism is configured to limit a maximum opening angle.

6. The appliance of claim 5, wherein the stop mechanism is configured to limit the maximum opening angle to less than 90 degrees.

7. The appliance of claim 5, wherein the stop mechanism is configured to limit the maximum opening angle to an angle in a range of about 50 degrees to about 60 degrees.

8. The appliance of claim 5, wherein the stop mechanism includes a stop block configured to engage the body of the appliance and the lid when the lid is opened to the maximum opening angle.

9. The appliance of claim 8, wherein the stop block is coupled to the lid.

10. The appliance of claim 8, wherein the stop block is coupled to the body of the appliance.

11. The appliance of claim 10, wherein:
the body of the appliance includes a handle, and
the stop block is coupled to the handle.

12. The appliance of claim 8, wherein the stop mechanism further includes a biasing element configured to urge the lid toward the fully open position when the lid is moved toward the closed position past a predetermined bias point.

13. The appliance of claim 12, wherein the biasing element includes a spring.

14. The appliance of claim 13, wherein the spring is a torsion spring.

15. An appliance, comprising:
a body;
a lid, hingedly connected to the body and configured to move between:
a closed position in which the lid covers a top of the body, and
a fully open position in which the lid does not cover the body; and
a stop mechanism attached to at least one of the body of the appliance and the lid, configured to limit an amount that the lid can be opened;
wherein an opening angle defines an angle between the top of the body and the lid when in the fully open position.

16. The appliance of claim 15, wherein the stop mechanism includes:
a contact surface coupled to the body of the appliance; and
a stop extension configured to engage the lid of the appliance so as to impede opening of the lid beyond a predetermined opening angle.

17. The appliance of claim 15, wherein the stop mechanism includes:
a contact surface coupled to the lid of the appliance; and
a stop extension configured to engage the body of the appliance so as to impede opening of the lid beyond a predetermined opening angle.

18. The appliance of claim 15, wherein the stop mechanism is configured to limit a maximum opening angle.

19. The appliance of claim 18, wherein the stop mechanism is configured to limit the maximum opening angle to less than 90 degrees.

20. The appliance of claim 18, wherein the stop mechanism is configured to limit the maximum opening angle to an angle in a range of about 50 degrees to about 60 degrees.

21. The appliance of claim 18, wherein the stop mechanism includes a stop block configured to engage the body of the appliance and the lid when the lid is opened to the maximum opening angle.

22. The appliance of claim 21, wherein the stop block is coupled to the lid.

23. The appliance of claim 22, wherein the stop block is coupled to the body of the appliance.

24. The appliance of claim 23, wherein:
the body of the appliance includes a handle, and
the stop block is coupled to the handle.

25. The appliance of claim 21, wherein the stop mechanism further includes a biasing element configured to urge the lid toward the fully open position when the lid is moved toward the closed position past a predetermined bias point.

26. The appliance of claim 25, wherein the biasing element includes a spring.

27. The appliance of claim 26, wherein the spring is a torsion spring.

28. The appliance of claim 15, wherein the appliance is a beverage brewer.

29. The appliance of claim 28, wherein the appliance is a coffee brewer.

30. The appliance of claim 15, further comprising a flare coupled to the body of the appliance to increase an anti-tipping stability of the appliance.
